(19) United States
(12) Patent Application Publication
(10) Pub. No.: US 2006/0190368 A1
(43) Pub. Date: Aug. 24, 2006

(54) System and method for determining the financial impact of an event

(75) Inventor: Noel J. F. Kesterman, Chevy Chase, MD (US)

Correspondence Address: MORRISON & FOERSTER LLP, 1650 TYSONS BOULEVARD, SUITE 300, MCLEAN, VA, 22102, US

(73) Assignee: NEXTEL COMMUNICATIONS, INC., Reston, VA (US)

(21) Appl. No.: 11/062,569

(22) Filed: Feb. 23, 2005

(51) Int. Cl. G06Q 40/00; G06F 7/00; G06F 17/00

(52) U.S. Cl. 705/35; 707/100

(57) ABSTRACT

The present invention provides a computer-based system, method and computer program product for inventorying assets and quickly determining the financial costs of an event impacting the location where such assets are located. A user is able to enter impact location identifiers and one or more asset impact variables using a user interface. A storage device stores an impact location profile for each of one or more impact location identifiers. An asset impact management module then retrieves an impact location profile corresponding to the impact location identifiers. The asset impact management module also retrieves at least one segment area analysis identifier. Each segment area identifier is associated with one or more segment area impact variables. A financial impact analyzer determines the financial costs of an event using the impact location profile, the segment area impact variables and the asset impact variables. Once the financial costs are determined, a financial impact analysis report is prepared for presentation on a display.

### BACKGROUND OF THE INVENTION

1. Field of Invention

This invention relates to the field of inventory computer based planning and management systems. More specifically, this invention relates to systems and methods for entering and maintaining asset data and determining the financial impact of an event impacting the location where assets are located.

2. Background

All organizations have assets in the form of personnel and physical property. In many instances these assets are dispersed throughout distant geographical locations. From time to time unexpected events such as natural disasters or accidents can occur where such assets are located. At other times an organization might have advance notice of an event which could potentially impact the organization's assets, such as an expected snow storm or heavy rainfall and flooding for example. In the face of such circumstances, it is necessary to assess the financial impact of such actual or potential damage to the organization's assets. With such an assessment, an organization is able to rank its operational response based on financial impact and determine how best to allocate its resources for recovering from or avoiding damage to its assets. Therefore, there is a need to quickly and conveniently determine the financial impact of an event on an organization's assets.

Moreover, most organizations have a need to communicate asset location, asset replacement value, potential revenue loss, and other risk exposures for insurance purposes. In the case of multi-national corporations, this task can be extremely difficult. Therefore, there is also a need to easily and accurately identify and communicate the location of an organization's assets, the replacement value of such assets, potential revenue loss associated with damage to the organization's assets, and other risk exposures.

### BRIEF SUMMARY OF THE INVENTION

The present invention is directed to a computer-based system, method and computer program product for inventorying assets and quickly determining the financial costs of an event. In particular, the present invention provides at least one storage device that stores an impact location profile for each of one or more impact location identifiers. The impact location profile identifies each of the assets associated with the impacted locations. A user is able to enter impact location identifiers and one or more asset impact variables using a user interface. The impact location identifiers identify the locations of an organization's assets that have been or are at risk of being impacted by an event. The asset impact variables are used to determine the scope of the event's impact on the organization's assets. Thus, the asset impact variables may include an asset impact parameter, a sales impact parameter, and an impact duration parameter.

The present invention also includes an asset impact management module having a controller in communications with the storage device. The controller is used to retrieve the impact location profile corresponding to the impact location identifier. In one method, the asset impact management module retrieves at least one segment area analysis identifier also entered by a user. Segment areas may include network, facilities, sales, or any other segment of an organization. Each segment area identifier is associated with a segment impact module. The segment area identifiers are used to identify one or more segment area impact variables that the financial impact analyzer uses to determine the financial costs of an event. In some instances, the segment area impact variables include network impact variables. The network impact variables include a lost revenue parameter, an asset replacement cost parameter, or a build-out cost parameter. In some instances, the segment area impact variables also include facilities impact variables. The facilities impact variables include a headcount driven parameter, an asset replacement cost parameter, or a build-out cost parameter. Still further, the segment area impact variables may also include sales impact variables. The sales impact variables include a personnel expense parameter, an asset replacement cost parameter, a sales revenue parameter, or a service revenue parameter.

A financial impact analyzer is used to determine the financial costs of an event using the impact location profile, the segment area impact variables and the asset impact variables. Once the financial costs are determined, the invention is also able to provide a financial impact analysis report for presentation on a display.

Further features of the present invention, as well as the structure and operation of various embodiments of the present invention are described in detail below with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated herein and form part of the specification, illustrate the present invention and together with the description, further serve to explain the principles of the invention and to enable a person skilled in the pertinent art to make and use the invention.

In the drawings, like reference numbers indicate identical or functionally similar elements. Additionally, the left-most digit(s) of a reference number identifies the drawing in which the reference number first appears.

FIG. 1 is an illustration depicting an example entity with geographically dispersed facilities.

FIG. 2 is an illustration depicting an example entity with geographically dispersed retail outlets.

FIG. 3 is a high level block diagram of an impact management system according to an embodiment of the present invention.

FIG. 4 is a block diagram of a general purpose computer system embodiment of the present invention.

FIG. 5 is an illustration depicting an impact management system using a client server architecture according to an embodiment of the present invention.

FIG. 6 is an illustration depicting an impact management system using a distributed network architecture according to an embodiment of the present invention.

FIG. 7 is an illustration depicting further features of an impact management system according to an embodiment of the present invention.

FIG. 8 is a flow chart diagram of a method for determining the impact of an event using an impact management system according to an embodiment of the present invention.

FIG. 9 is a flow chart diagram of a method for determining the impact of an event to a network according to an embodiment of the present invention.

FIG. 10 is an illustration depicting an event.

FIGS. 11-15 are illustrations depicting screen shots presented on a display associated with a user interface device according to an embodiment of the present invention.

FIG. 16 is a flow chart diagram of a method for determining the impact of an event to facilities according to an embodiment of the present invention.

FIGS. 17-22 are illustrations depicting screen shots presented on a display associated with a user interface device according to an embodiment of the present invention.

FIG. 23 is a flow chart diagram of a method for determining the impact of an event of sales according to an embodiment of the present invention.

FIGS. 24-28 are illustrations depicting screen shots presented on a display associated with a user interface device according to an embodiment of the present invention.

FIGS. 29A-29B are illustrations depicting screen shots presented on a display associated with a user interface device according to an embodiment of the present invention.

### DETAILED DESCRIPTION OF THE INVENTION

1. Overview of the Invention

The present invention is directed to a system, method, and computer program product for enabling an organization to quickly determine the financial impact of an event on the organization's assets. The invention is particularly well suited and useful for quickly identifying the location of an organization's assets and communicating an understanding of potential revenue loss and other risk exposures resulting from reduced usage or total loss of an asset.

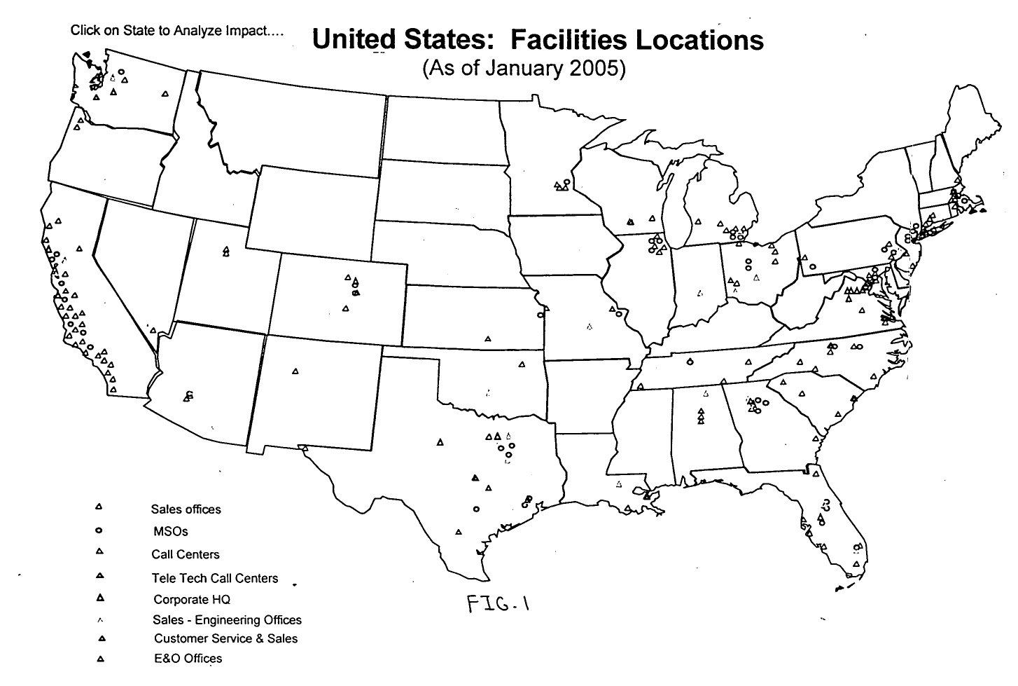

Referring initially to FIG. 1, an example map of an organization having geographically dispersed facilities is shown. In the example provided, the location and type of each facility is indicated on the map. Each of these facilities are considered assets of the organization. In the case of a telecommunications services provider, such facilities might include sales offices, switching offices, customer call centers, and corporate management offices for example. As explained in further detail below, additional assets of the organization can be found within such facilities. Examples of such additional assets include personnel and equipment. In an embodiment of the present invention, one or more asset type indicators are used to visually distinguish one type of asset from another. Such asset type indicators can be implemented as symbols, icons, etc.

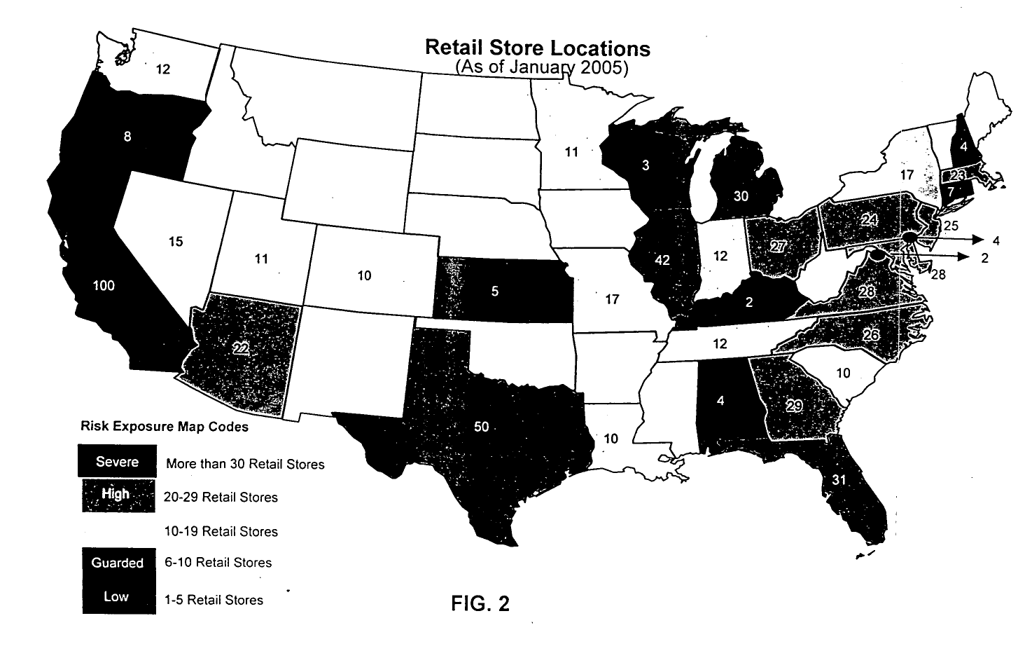

As illustrated in FIG. 2, an organization's facilities might also include retail store outlets. In this example, the number of retail stores located in a particular state is indicated. Each of the locations identified in FIG. 1 house assets of one type or another. Such assets may include personnel as well as physical assets. For a telecommunications services provider, physical assets might include computer hardware, computer software, and telecommunications equipment such as antennas, networking switches, etc. In accordance with one embodiment of the present invention, a risk exposure indicator such as highlighting or color is used to visually distinguish the risk level of one location in comparison to another. For example, low risk locations might be presented in green, moderate risk locations in yellow, and high risk locations in red.

The parameters and relative weights for deciding the risk level can vary. For example, risk levels might be determined based on the number of assets at risk at any given location. Still further, risk levels might be determined based on the value of the assets at risk at a given location. Still further, risk levels might also be determined based on the organization's customers that are or would be impacted by the event. In yet another embodiment, risk levels can be determined based on the likelihood of an event occurring where the assets are located. For example, an organization's assets might lie in an area prone to hurricanes, earth quakes, floods, and similar natural disasters. In today's environment, an organization's assets might also be in an area more at risk to terrorists' attacks. For this reason, too, an organization might attribute one location with a higher risk level than another.

2. Exemplary Structural Environment

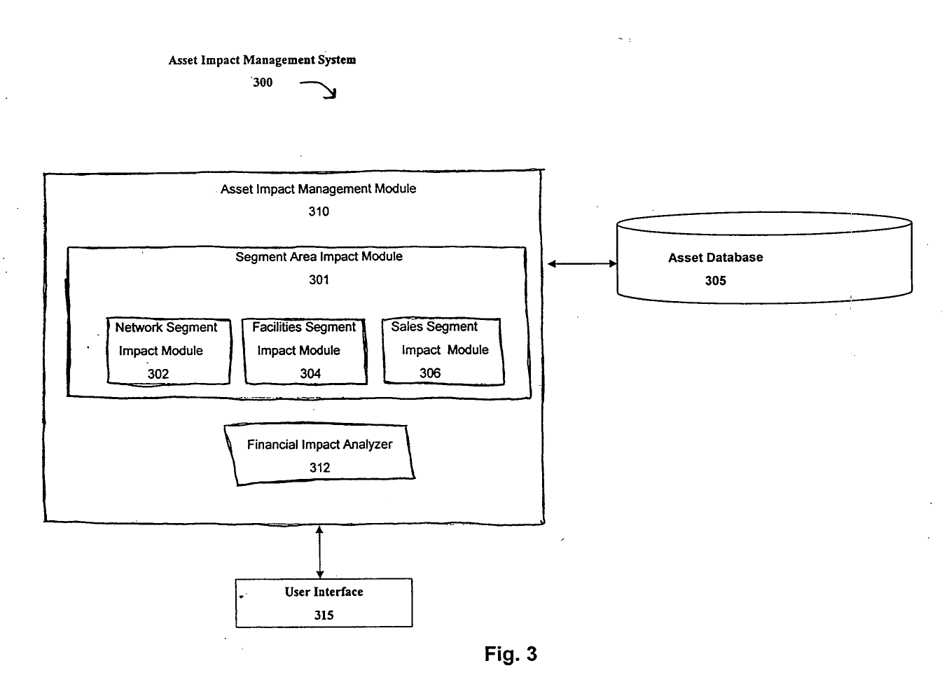

Referring to FIG. 3, an asset impact management system 300 will now be described according to embodiments of the present invention. The invention, however, is not limited to these example embodiments. Other implementations of the system 300 will be apparent to persons skilled in the relevant arts based at least in part on the teachings contained herein.

2.1 Asset Impact Management System

FIG. 3 is a high level block diagram of the asset impact management system 300. The system 300 includes an asset database 305. The asset database 305 contains an asset profile for each of the organization's assets to be tracked using system 300. The asset profiles may contain information pertaining to the asset such as a serial number and replacement cost in the case of a physical asset. With respect to personnel, the asset profile may contain such information as social security number, compensation, or a visual image of the employee, for example.

Asset impact management system 300 also includes a user interface 315. User interface 315 provides interaction between a user and system 300. In particular, user interface 315 allows a user to access the functionality of asset impact management module 310. Further, the user interface 315 allows the user to enter asset variable information such as the extent to which it has been impacted or the length of time it has been impacted, for example.

The asset information is preferably received at the asset impact management module 310. Asset Impact Management Module 310 may contain processor controlled computer software routines used for determining the financial costs of an event impacting the location where the assets are located. In one embodiment, processor controlled computer software routines are contained in one or more segment area impact modules 301 corresponding to specific business segments of the organization. The segment area impact modules 301 are used to identify impact variables used for determining the financial costs of an event. In the present example, a network segment impact module 302, a facilities segment impact module 304, and a sales segment impact module 306 are shown.

As will be described further below, users may access and traverse the functions provided by the asset impact management module 310 in any number of ways via interaction with menus, voice recognition or clicking on icons or depressing keys provided by the user interface 315. Other ways of accessing asset impact management module 310 will be apparent to persons skilled in the relevant arts based at least on the teachings contained herein.

2.2 Computer System Embodiment

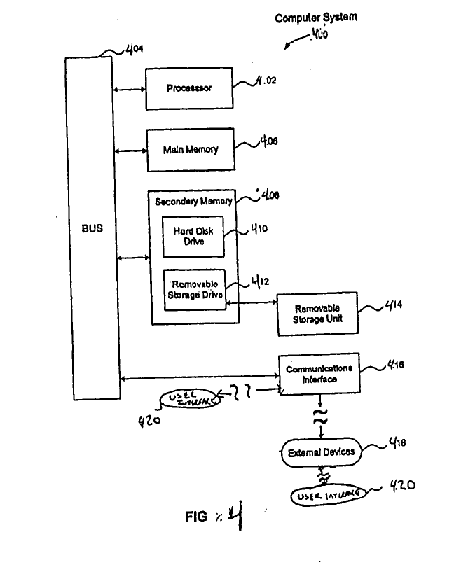

In one embodiment, the components of the asset impact management system 300, shown in FIG. 3, can be implemented in whole or in part using a conventional computer system 400, the components of which are shown in FIG. 4. The conventional computer system 400 could be a conventional personal computer, a personal data assistant, wireless phone, mobile device, cable or satellite set top box or electronic tablet or combinations of any of the above operably in communications with one another.

The computer system 400 includes one or more processors 402 connected to a communication bus 404. The computer system 400 also includes a main memory 406. Main memory 406 may be random access memory (RAM), read only memory (ROM), EPROM, and/or EEPROM. Computer system 400 further includes secondary memory 408. Secondary memory 408 includes, for example, hard disk drive 410 and/or removable storage drive 412. Removable storage drive 412 could be, for example, a floppy disk drive, a magnetic tape drive, a compact disk drive, DVD, a program cartridge and cartridge interface, or a removable memory chip. Removable storage drive 412 reads from and writes to a removable storage unit 414. Removable storage unit 414, also called a program storage device or computer program product, represents a floppy disk, magnetic tape, compact disk, or other data storage device.

Computer programs or computer control logic are stored in main memory 406 and/or secondary memory 408. Thus, for example, the asset impact management module (AIMM) routines may be stored in either main memory 406 and/or the secondary memory 408. Preferably, processor 402 of other controller in the general purpose computer may operate as the AIMM controller. Further, the asset database 305, which contains the asset profiles, could be implemented in main memory 406 or secondary memory 408.

Computer system 400 further includes a communications interface 416. Communications interface 416 enables the computer system 400 to send and receive software and data to/from external devices 418. Information may be communicated from the communications interface 416 over any transmission known in the art including wireless or wireline networks, cable distribution back channels, online information networks, Internet, Intranet or any other transmission means known in the art. Examples of communications interface 416 include a modem, a network interface, and a communications port.

As discussed above, the asset impact management system 300 may be centralized in a single computer system 400 with the module containing processor 402 controlled programs residing in memory 406, 408 or 418.

Referring still to FIG. 4, the user interface 420 may be a keyboard, remote controller device, personal data assistant, cell phone punch pad, a microphone and voice recognition system, or any other conventional means to enter data. The user interface 420 may connect directly to the general purpose computer 400 or to an external device 418, as shown in FIG. 4.

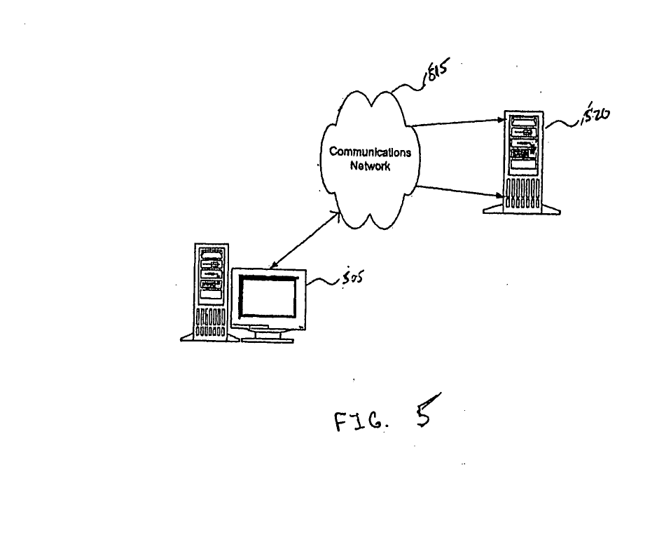

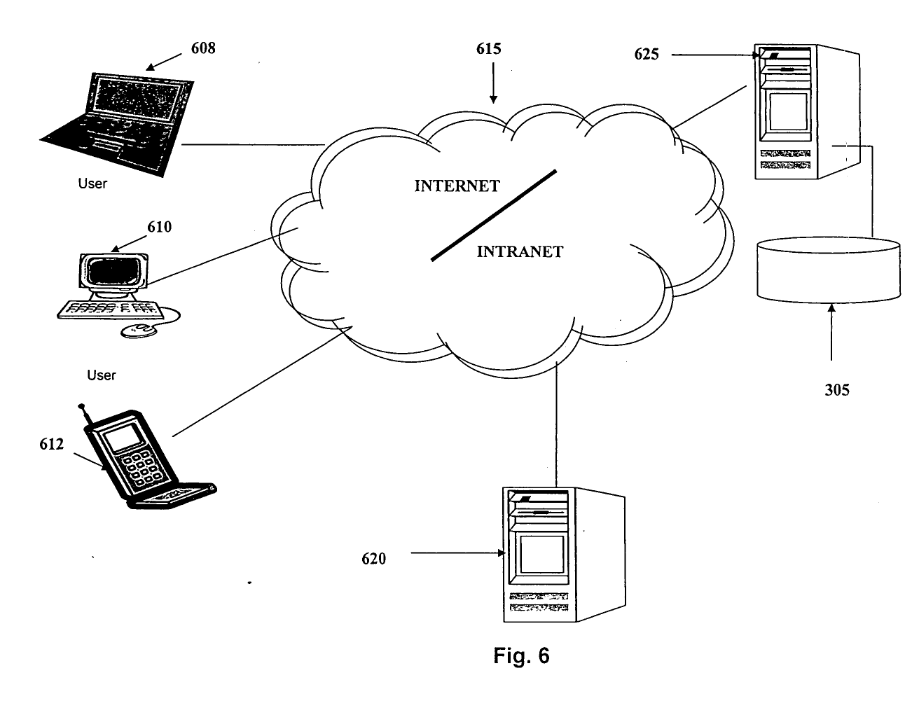

In other embodiments, the asset impact management system 300 is distributed among multiple computer networked systems, examples of which are shown in FIGS. 5 and 6, as explained in further detail below. The degree of centralization or distribution is implementation and/or application dependent.

For example, consider FIG. 5 which illustrates an embodiment of the present invention. In this embodiment, asset impact management module 310 containing controller software and asset database 305 could each reside in host computer 520. A user accesses asset impact management module 310 over communications network 515 using user interface 420, depicted in the example as a general purpose computer 505. As with FIG. 4, the user interface 420 may be the computer 505 or partially or wholly implemented via keyboard, remote controller device, personal data assistant, cell phone punch pad, a microphone and voice recognition system, or any other conventional means to enter data. Of course, the user interface 305 may alternatively be a personal data assistant, wireless phone, mobile device, cable or satellite set top box or electronic tablet in this embodiment acting alone or in combination with the general purpose computer 505. Communications network 515 may be wireless or wireline networks, mobile networks, cable or satellite distribution, online information networks, Internet, Intranet or any other transmission means known in the art.

Alternatively, the routines and functions of the asset impact management module 310 could be implemented solely within the terminal 505 or shared between the terminal 505 and the host computer 520 in a client/server relationship. For example, the user may enter impacted asset information via user interface into the computer terminal 505. The asset impact management module 310 formats and sends the impacted asset information and a request via communications network 515 to the host computer 520. At the host computer 520, the host computer controller component of the asset impact management module 310 receives and processes the request from the terminal 505. Under processor control, the asset impact management module 310 searches the asset database 305 stored in either local or remote storage according to the processes described in more detail below to obtain the resultant financial costs. The resultant financial cost is preferably communicated back to the terminal 505 and displayed or printed out to the user. In this way, the AIMM module located at the computer terminal 505 provides input/output functionality and the AIMM module located at the host computer 520 performs the financial analysis.

Referring to FIG. 6, in yet another embodiment, user interface 315 could reside in personal computer 610, laptop 608, wireless phone 612 or any other conventional device. Communications network 615 may be wireless or wireline networks, mobile networks, cable or satellite distribution, online information networks, Internet, Intranet or any other transmission means known in the art. Using communications network 615, personal computer 610 or any other of the user interface devices could then access asset impact management module 310, preferably residing on computer 620. The computer 620 may forward the requests and impacted asset information via a network interface such as a web browser, for example, if the communications network is the Internet or Intranet. These systems may use transactional software communications protocols well known in the art to request and receive services from servers. In this regard, computer 620 may be configured to operate as a web server. The asset impact management module 310, residing on host computer 625, may then direct searches of the asset database 305, also residing on host computer 625, and conduct an impact analysis in accordance with embodiments of the present invention.

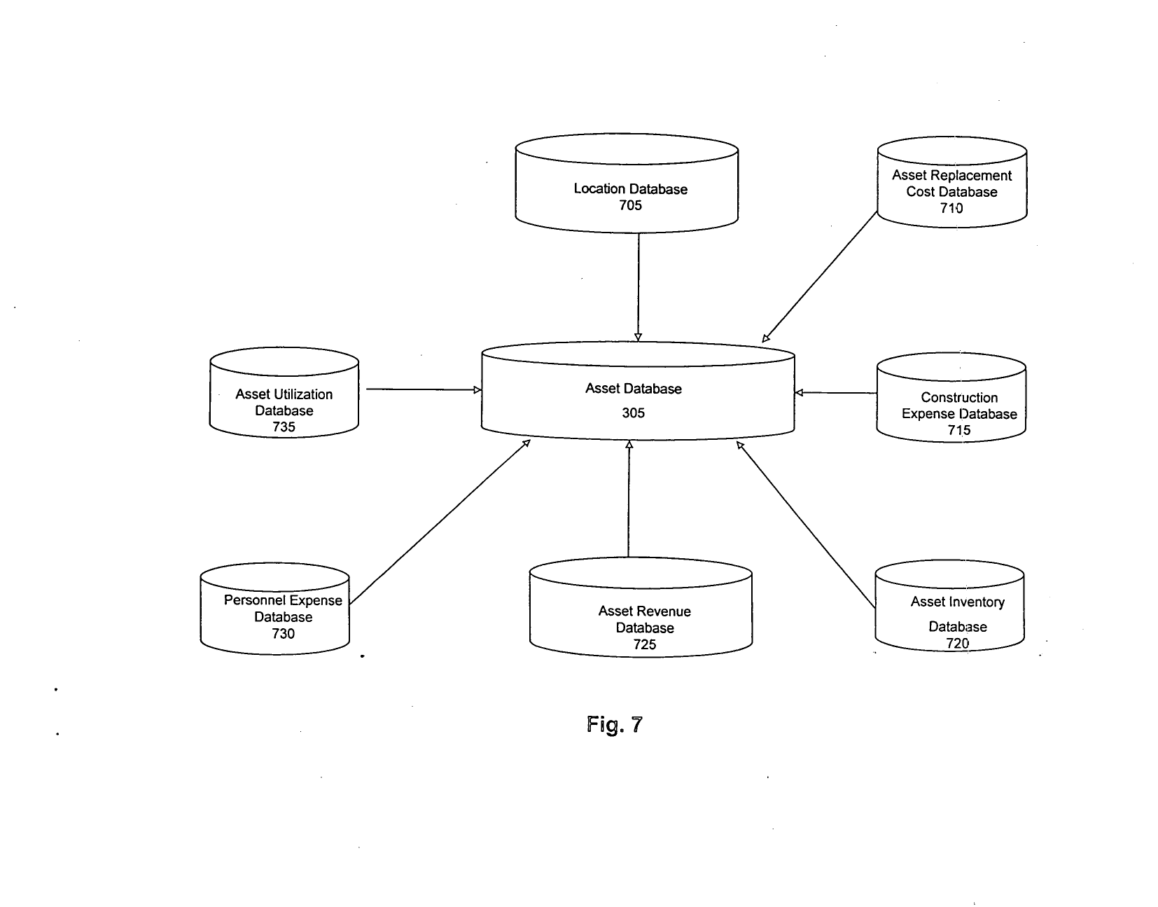

Referring to FIG. 7, a number of data sources may be used to maintain and provide information to asset database 305 for use in determining the financial costs of an event. For example, location database 705 may provide information identifying each of the locations where an organization has assets. Still further, location database 705 may also store contact list identifying persons to be notified whenever an event impacts a specific location. Still further, location database 705 may also be used to store floor plans or similar schematics of each of the organization's facilities. Asset replacement cost database 710 may provide costs associated for obtaining a new asset to replace the impacted asset. The construction expense database 715 may provide costs associated with building a new location or space within the impacted location. The asset inventory database 720 may provide information identifying each of the organization's assets. Asset Revenue Database 725 may provide historical data identifying the amount of revenue derived from the use of a particular asset. Such information is useful for determining the amount of revenue being lost whenever the asset is not in use or operating at less than its normal level. Personnel expense database 730 may be used to store costs associated with personnel such as for example compensation, insurance, commissions, etc. Asset utilization database 735 provides information identifying how much a particular asset is typically utilized.

The asset database 305 serves as a central repository of the asset data collected from the various data sources. Preferably, the accumulated asset data is combined into asset profiles and subsequently formatted and stored in databases commonly known in the art.

3.0 Exemplary Operation of the Invention

3.1 Operation

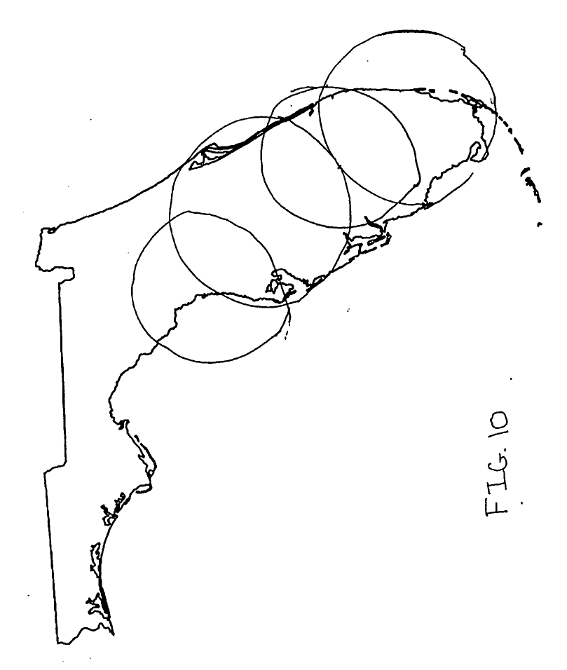

The methods of operation of the present invention will now be described. The present invention is useful for providing financial impact analysis based on predictive scenarios. In this way, an organization can simulate events and prepare responses before the occurrence of an actual event. For example, an organization might be contemplating the relocation of some of its assets. Still further, an organization might want to determine the potential losses that might be caused by a hurricane, fire, flood, earthquake, or similar event impacting the organization's assets. By simulating such events before hand, the organization is better able to develop a plan to mitigate such potential losses. Similarly, in the aftermath of an actual event, the invention may also be used to determine the financial impact of the event on the organization's assets. This information can then be used by the organization in preparing its recovery plan. For purposes of illustration, the invention will be described in the context of assessing the impact of a hurricane projected to impact an organization's assets. An indication of the projected path of the hurricane is illustrated in FIG. 10.

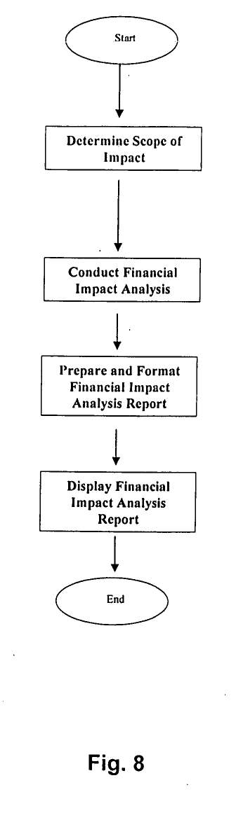

Referring now to FIG. 8, flowchart 800 illustrates one manner in which a user interacts with system 300 via user interface 315 to determine the financial costs of an event impacting the location where an organization's assets are located.

Flowchart 800 begins with step 802. In step 802, the user invokes asset impact management system 300 in any well known manner, such as selecting an icon associated with the asset impact management system 300. Step 802 may also include steps for authenticating the user and verifying authorized access to system 300.

In step 805, the scope of the hurricane's impact on the organization's assets is determined. The present invention may be configured to assess the impact of an event on any segment of the organization. For example, assessments may be performed for the organization's network assets, facilities, or sales outlets. Thus, step 805 includes the step of a user selecting a segment area to be analyzed. In response to this selection, a segment area analysis identifier would be provided to the asset impact management module 310. In an embodiment of the present invention, segment impact modules corresponding to each segment area analysis identifier are also provided. The segment area impact modules are used to identify impact variables needed to determine the financial impact of the event. In the present example, system 300 will be described with reference to network segment impact module 302, a facilities segment impact module 304, and a sales segment impact module 306.

The implementations described herein focus only on an organization's network, facilities, and retail sales outlets segments. However, the teachings of the present invention can be applied to any segment or functional area of an organization without departing from the spirit and scope of the present invention. For example, the customer care segment of an organization is responsible for responding to inquiries from customers. An event impacting the responsiveness of the customer care segment might cause customers to cease doing business with the organization which would result in a cost to the company in the form of lost revenue. Similarly, there are costs associated with the training of new employees and the retention of existing employees. Thus, events which result in the need to hire new employees or respond to additional stress placed on existing employees as a consequence of an event can also be considered in the financial impact analysis.

A. Network Impact Assessment

In a first example implementation of the invention, the financial impact of an event affecting the network of an organization will be described. Accordingly, a network segment identifier would be provided to asset impact management module 310. In response to receiving the network segment identifier, asset impact management module 310 would utilize network segment impact module 302 to identify the location where the organization has network assets using information obtained from asset database 305, location database 705, or a combination of the two.

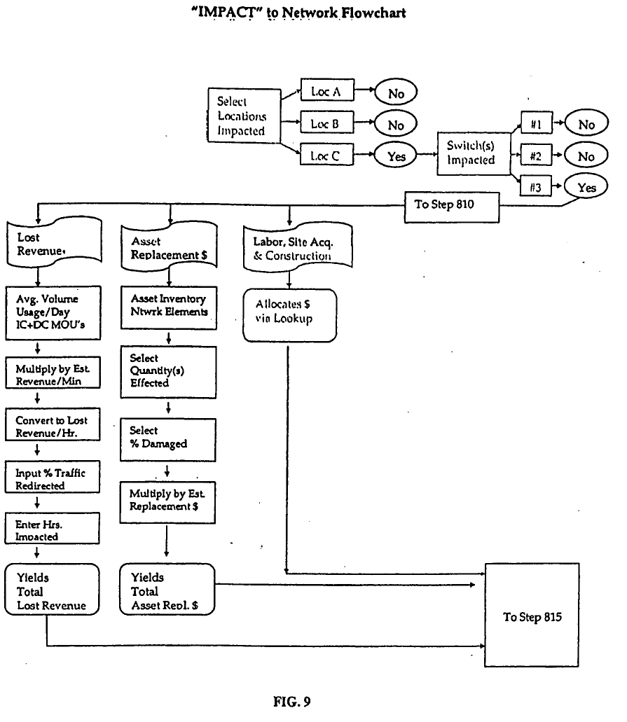

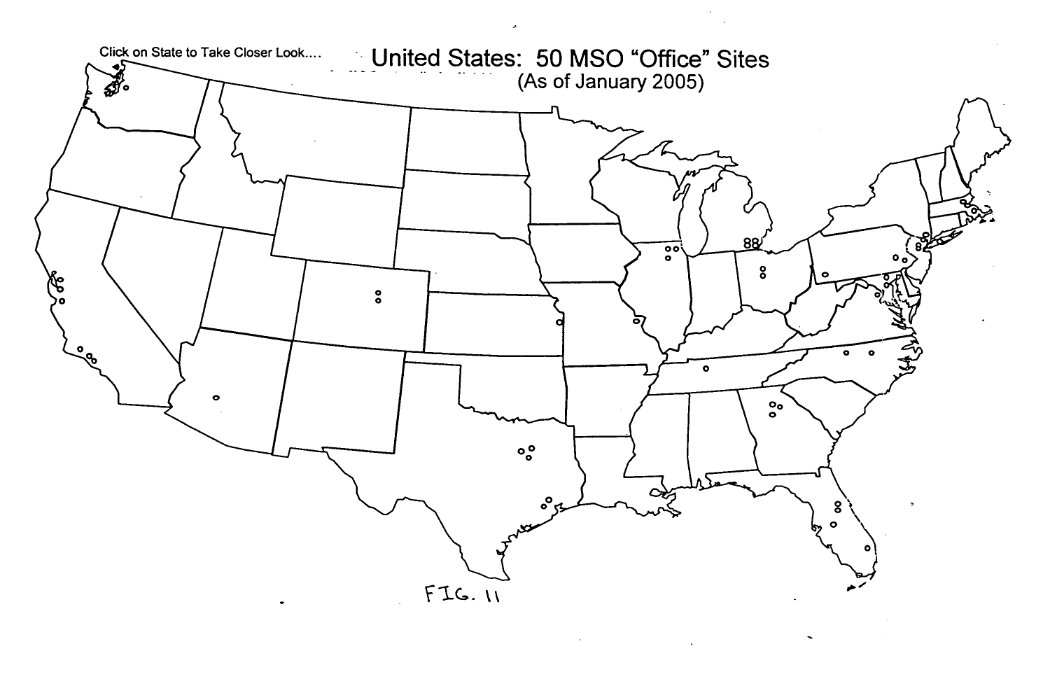

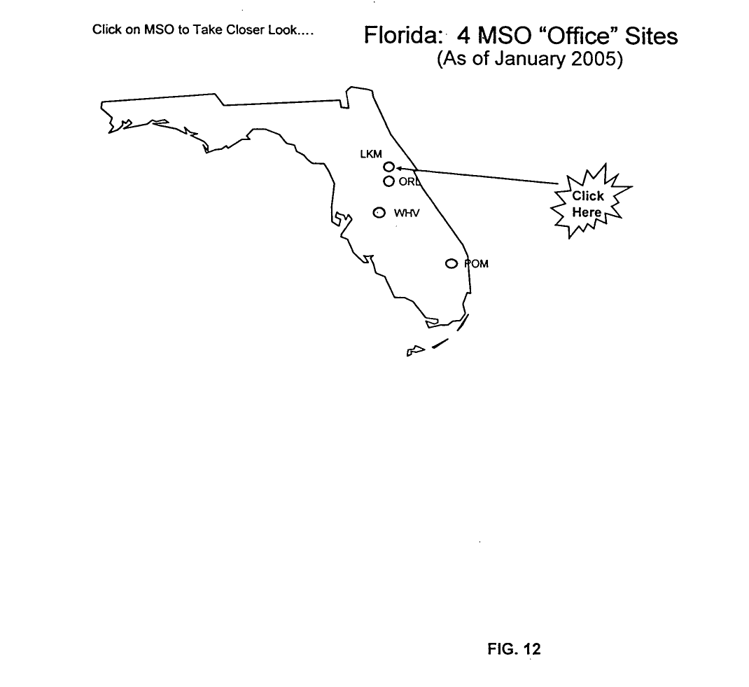

Referring now to FIG. 9, the user is asked to identify the locations impacted by the hurricane. As shown in FIG. 11, in an embodiment of the present invention, the location of the organization's network assets are presented on an interactive geographical display. In this way, the user is able to select the impacted locations using a mouse or similar device. The manner of generating the interactive geographical display will be apparent to persons skilled in the relevant arts. In the present example, the user selects the state of Florida. As shown in FIG. 12, in embodiments of the present invention, the impacted location can be further identified by selecting a specific location within a geographical area. In this case, the Lake Mary (LKM) location is selected. Once the impacted locations are selected, impact location identifiers are provided to network segment impact module 302. In an embodiment, an impact location identifier is provided for each of the selected locations. Network Segment Impact Module 302 then retrieves an impact location profile for each of the impact location identifiers. In an embodiment, each impact location profile includes information identifying the network assets associated with the respective impacted locations. For a telecommunications company, examples of such assets include, without limitation, transmitters, receivers, servers, mixers, encryption/decryption devices, encoder/decoders, antennas, network switches, base station controllers, transmission lines and facilities, and other telecommunications devices.

In an embodiment of the present invention, the user is also presented with a list of each of the network assets and prompted to identify those assets impacted by the event. Once the network assets impacted by the hurricane have been identified, a financial impact analysis can be performed in accordance with embodiments of the present invention.

In an embodiment of the present invention, the user may be providing information to the system while located proximate to the impacted network assets. In this way, the user's determination of the impact can be based on a direct visual assessment of the assets. In another embodiment, persons proximate to the impacted network assets might provide information about the impacted assets to a remotely located user who then provides such information to the system. Still further, impact information might be obtained from systems designed to monitor the performance of the organization's network assets.

Referring again to FIG. 8, in step 810, financial impact analyzer determines the financial costs of the hurricane on the organization with respect to the impacted network assets. In an embodiment, the financial costs are determined based on the determined scope of the event and a financial impact analysis of one or more asset impact variables associated with the impacted network assets. The asset impact variables include an asset impact parameter, a sales impact parameter, or an impact duration parameter, for example. The asset impact parameter is used to indicate the extent to which a particular asset is impacted. For example, the asset impact parameter might indicate that a network asset is only fifty percent (50%) operational. The sales impact parameter is used to indicate the amount of revenue derived from utilization of the network asset. Lastly, the impact duration parameter indicates the amount of time the network asset is operating at less than one hundred percent of its usual performance level. Each segment of an organization may have its own unique set of variables that need to be considered when determining the financial impact of an event. Accordingly, in embodiments of the present invention, segment impact variables may be taken into consideration. For example, with respect to the network segment of an organization, network impact variables such as lost revenue, asset replacement costs, as well as labor, site acquisition and construction costs associated with site build-outs may all be considered in the financial impact analysis.

A more detailed explanation of step 810 will now be described with reference again to FIG. 9. In an embodiment of the present invention, the total lost revenue resulting from damage to network assets of the organization is determined. Total lost revenue is determined by first dividing the average volume of use for the impacted network asset by the number of days the network asset is impacted. This result is then multiplied by the estimated amount of revenue per minute. Next, the amount of revenue lost is determined on a per hour basis. It may be possible to mitigate some revenue loss by rerouting the network traffic typically carried by the impacted network asset. Thus, the percentage of network traffic redirected is also determined. Finally, the duration of time that the network asset is impacted is determined. In some cases, this time will be an estimate of the amount of time the network asset will be impacted. In other cases, this time will reflect the actual amount of time the network asset has been impacted.

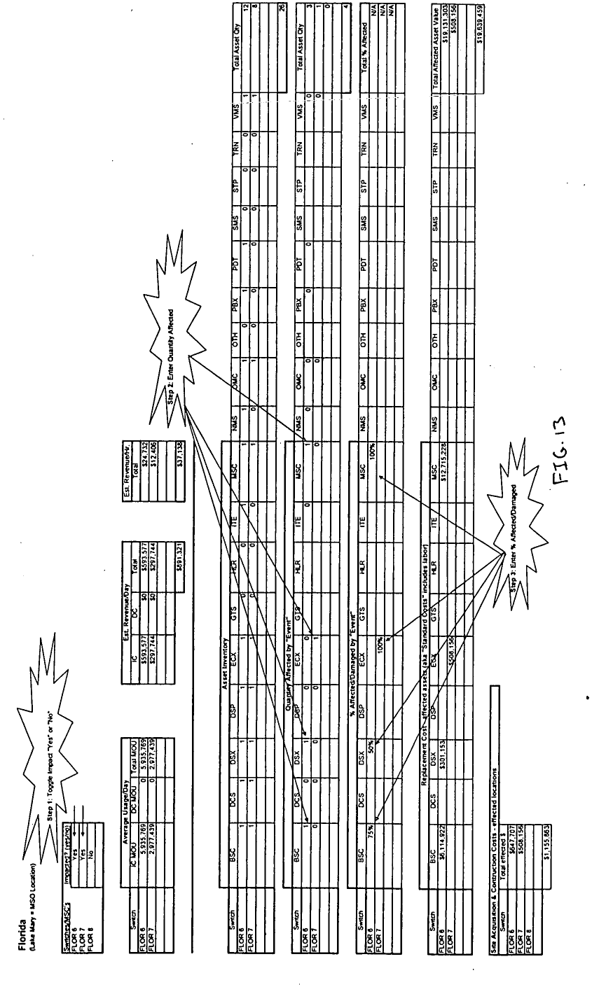

In some cases the impact to a network asset will require replacement of the network asset. Therefore, in an embodiment of the present invention, the asset replacement cost parameter is determined by identifying the number of network assets impacted and the percentage of damage sustained by each asset. Once determined, this result is multiplied by the estimated replacement cost for the network asset. In catastrophic situations, an entire network facility might be destroyed. In such situations, the costs associated with build-outs of a new site must be considered. Such costs, include for example, labor, site acquisition costs, and construction costs. As shown in FIG. 13, the user can be presented with an interactive display of the network impact variables. In this way, the user can select and/or enter information related to the network assets impacted. Once each of the above described calculations are made, asset impact management system 300 is ready to prepare and format the financial impact analysis report. Thus, control returns to step 815 (FIG. 8).

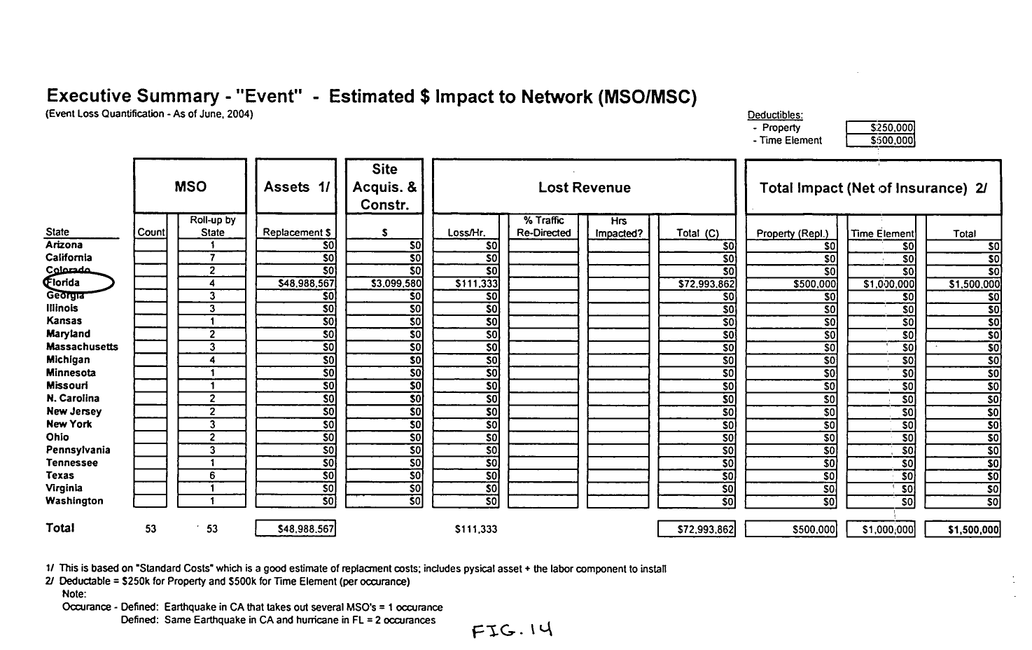

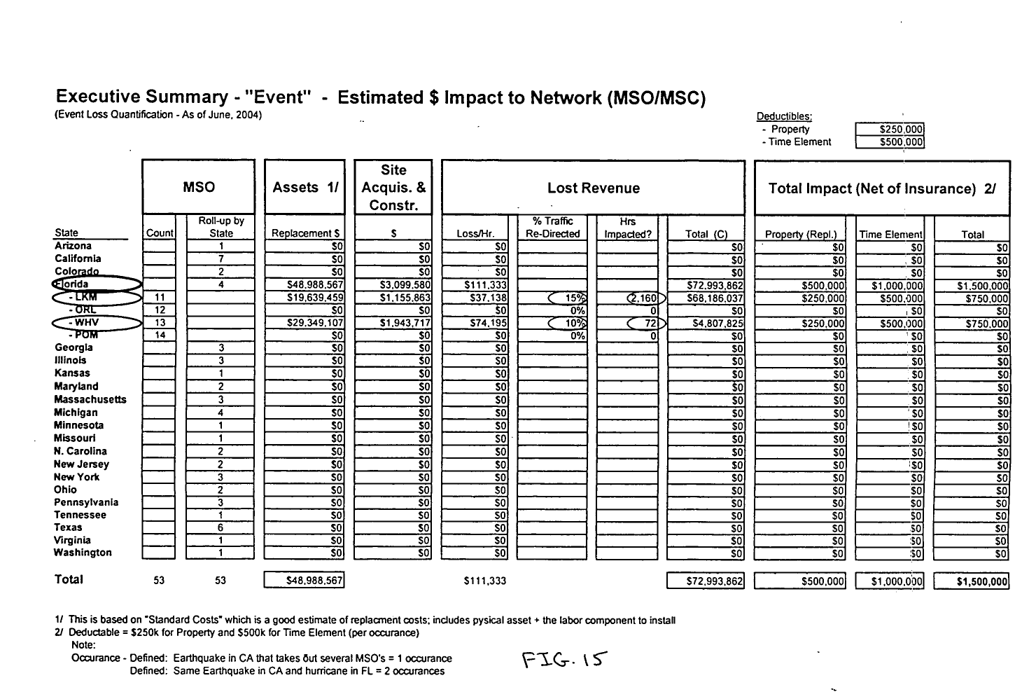

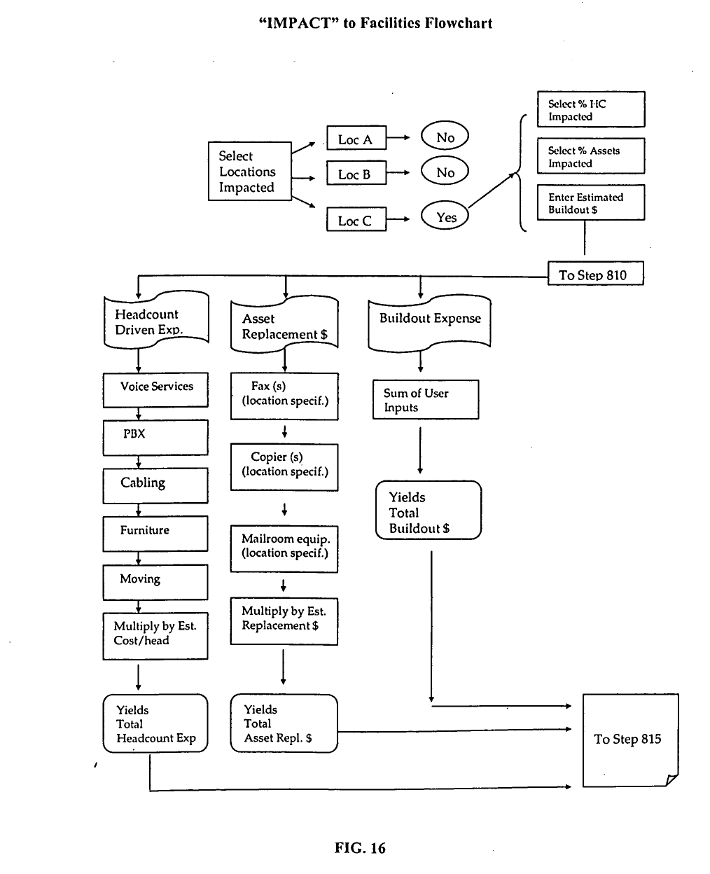

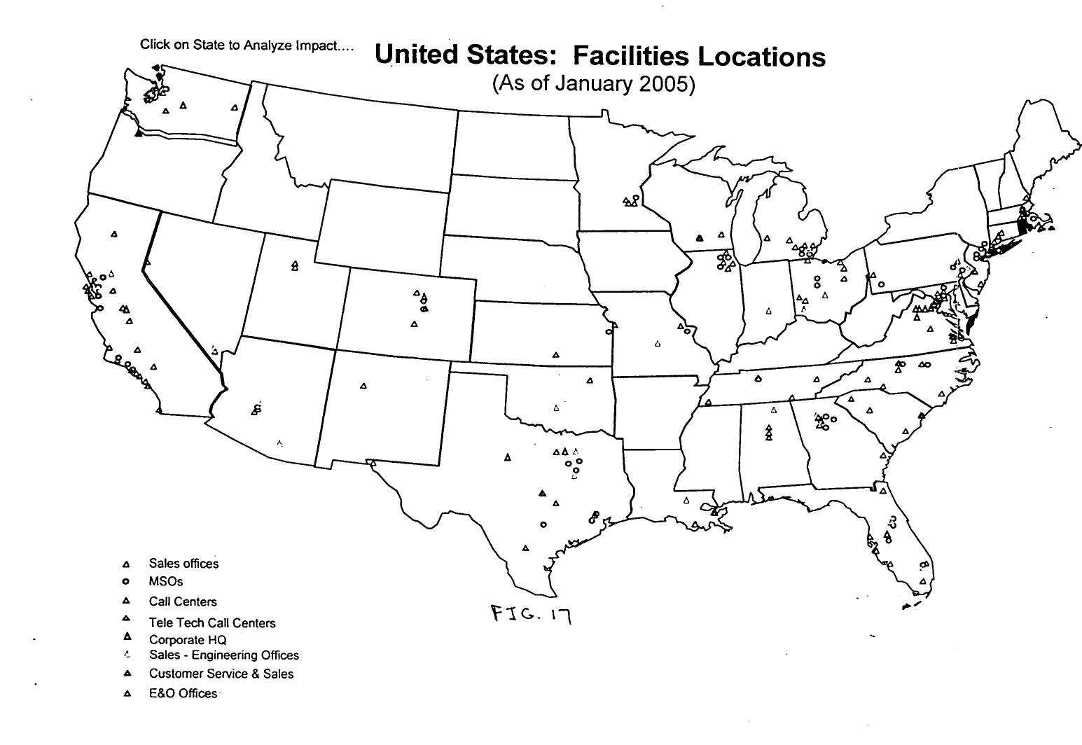

FIGS. 14 and 15 illustrate example screen shots of a financial impact analysis report presented to a user according to an embodiment of the present invention. In an embodiment of the present invention, the financial impact analysis report is sent to persons identified on a contact list associated with the impacted facility. In this way, executives, managers, engineers, technicians, or others needing to be involved in the early assessment or response to an event can be quickly notified. The system may be configured to send the report to such persons automatically or in response to a user request. The user request can be made in any well known manner, such as selecting an icon or activating a button.

Referring first to FIG. 14, the user is able to see a high level assessment of the estimated financial impact that an event has on the organization's network assets. In this case, an initial view by state is presented. In an embodiment of the present invention, the user can drill down for more detailed information by selecting a particular state. As shown in FIG. 15, the financial impact for each of the Florida locations having impacted network assets is displayed. In an embodiment of the present invention, one or more of the asset impact variables can be modified. For example, referring again to FIG. 13, a user might indicate that the BSC on floor 6 is only 50% affected as opposed to the originally estimated 75%. According to embodiments of the present invention, the financial impact analysis is updated whenever the asset impact variables are modified.

In accordance with embodiments of the present invention, the resultant financial impact analysis can be formatted for presentation on display operably connected to a general purpose computer 610 (FIG. 6). However, today's organizational management and staff is mobile and therefore not always able to access a general purpose computer. For this reason, the present invention is further able to be accessed from mobile devices, such as a portable computing device (608) or wireless device (612) also shown in FIG. 6. In this way, information can be provided to the organization from remote locations and more importantly, the organization's decision makers can receive information wherever they might be located.

In the present example, the resultant financial impact analysis has been formatted and displayed in a spreadsheet format. In another embodiment, the resultant financial impact analysis may be displayed in a HTML format. In yet another embodiment, the financial impact analysis may be displayed in a text file format. Persons skilled in the relevant arts will recognize other ways of formatting and displaying the resultant financial impact analysis without departing from the spirit and scope of the present invention.

B. Facilities Impact Assessment

A second example implementation of the invention will now be described in the context of determining the financial impact of an event affecting the facilities of an organization. In response to a user's selection of the facilities segment of an organization, a facilities segment identifier would be provided to asset impact management module 310. In response to receiving the facilities segment identifier, asset impact management module 310 would utilize facilities segment impact module 304 to identify the location where the organization has facility assets.

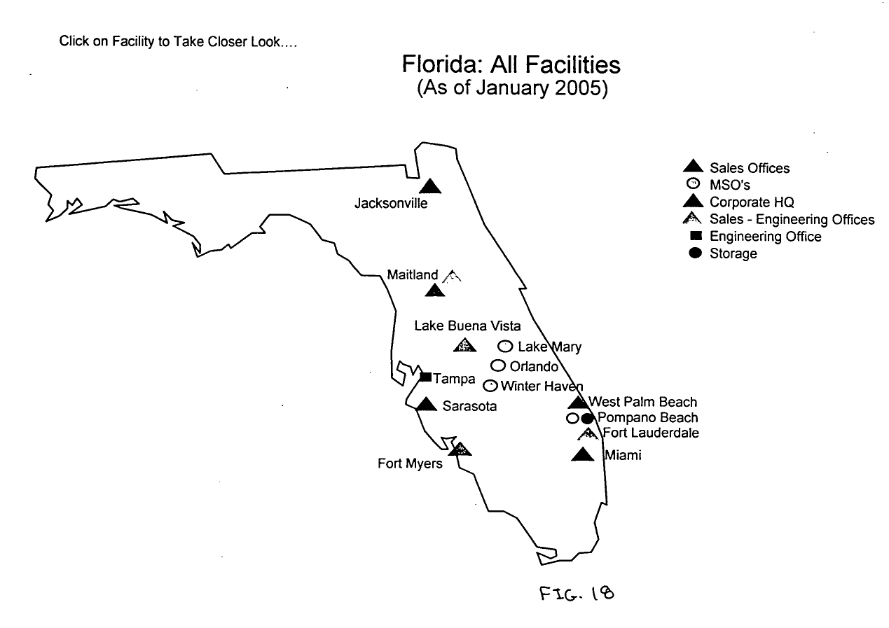

According to embodiments of the present invention, information identifying the location where the organization has physical facilities is obtained from asset database 305, location database 705, or a combination of the two. As shown in FIG. 17, in an embodiment of the present invention, the locations of the organization's facilities are presented on an interactive geographical display. In this way, the user is able to select the impacted locations using a mouse or any other user interfaces known in the art. In a first step, the user is asked to identify the locations impacted by the hurricane. In the present example, the user selects the state of Florida. As shown in FIG. 18, in embodiments of the present invention, the impacted location can be further identified by selecting a specific location within a geographical area. In this case, the city of Miami is selected. Once the impacted locations are selected, impact location identifiers are provided to facilities segment impact module 304. In an embodiment, an impact location identifier is provided for each of the selected locations. Facilities Segment Impact Module 304 then retrieves an impact location profile for each of the impact location identifiers. In an embodiment, each impact location profile includes information identifying the facilities associated with the respective impacted locations. For a telecommunications company, examples of such facility assets include, without limitation, corporate offices, sales offices, and engineering offices.

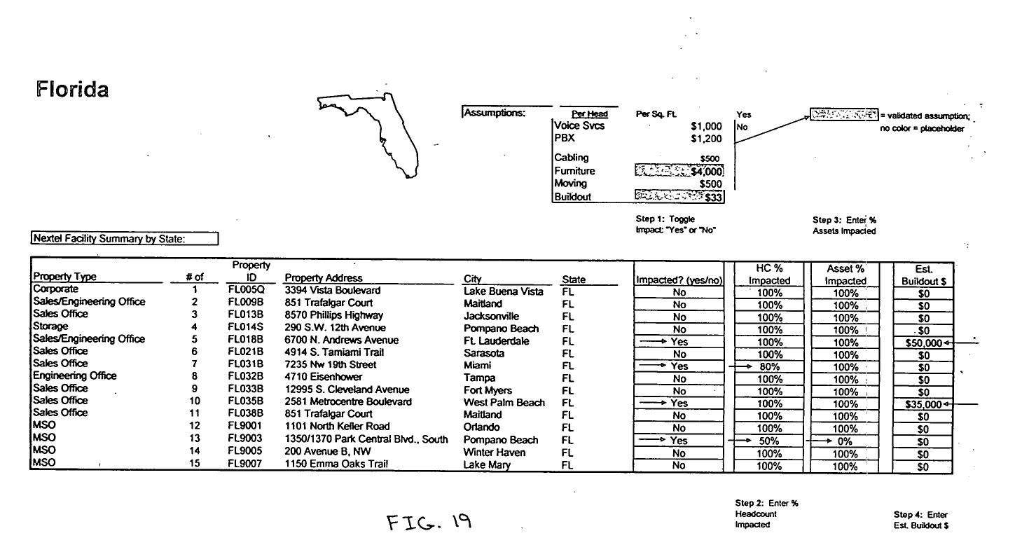

Referring to FIG. 19, in an embodiment of the present invention, the user is presented with a list of each of the facilities and prompted to identify those facilities impacted by the event. In the present example, the user would also provide facilities impact variables such as the extent to which a particular facility has been impacted, the number of personnel affected at the impacted facility, and the estimated costs to repair the impacted facility. In an embodiment of the present invention, the user may be located at the impacted facility. In this way, the user's determination of the impact can be based on a direct visual assessment of the assets. In another embodiment, persons at the impacted facility might provide information about the impacted assets to a remotely located user who then provides such information to the system. Still further, impact information might be obtained from systems designed to monitor the performance of certain assets within the facility.

Once the scope of the facility assets impacted by the hurricane has been determined, a financial impact analysis can be performed in accordance with embodiments of the present invention. Referring again to FIG. 8, in step 810, financial impact analyzer determines the financial costs of the hurricane on the organization. In an embodiment, the financial costs are determined based on the determined scope of the event and a financial impact analysis of one or more facilities impact variables associated with the impacted facility assets. The facilities impact variables can include a headcount driven parameter, an asset replacement costs parameter, or a build-out cost parameter. These parameters correspond to the information provided by the user as described above in connection with step 805.

To determine the financial costs of the event with respect to impacted facilities, the total costs associated with the personnel affected at the impacted locations is determined. Referring again to FIG. 19, in the present example, eighty percent (80%) of the personnel at the Sales Office in Miami and fifty percent (50%) of the personnel at the MSO location in Pompano Beach have been identified as affected by the event. In an embodiment, total headcount expenses are determined by multiplying the number of affected personnel by the total facility expenses associated with each person. Such facility expenses might include, for example, expenses incurred for providing voice mail and other telephone services, computer connection cabling, obtaining office furniture, and moving. In some cases, the impact to a facility asset will require the replacement of assets within the facility. For example, facsimile and copier machines may need to be replaced. Similarly, mailroom equipment such as postage metering machines may require replacement. Therefore, in an embodiment of the present invention, the total cost is also determined for replacing these assets.

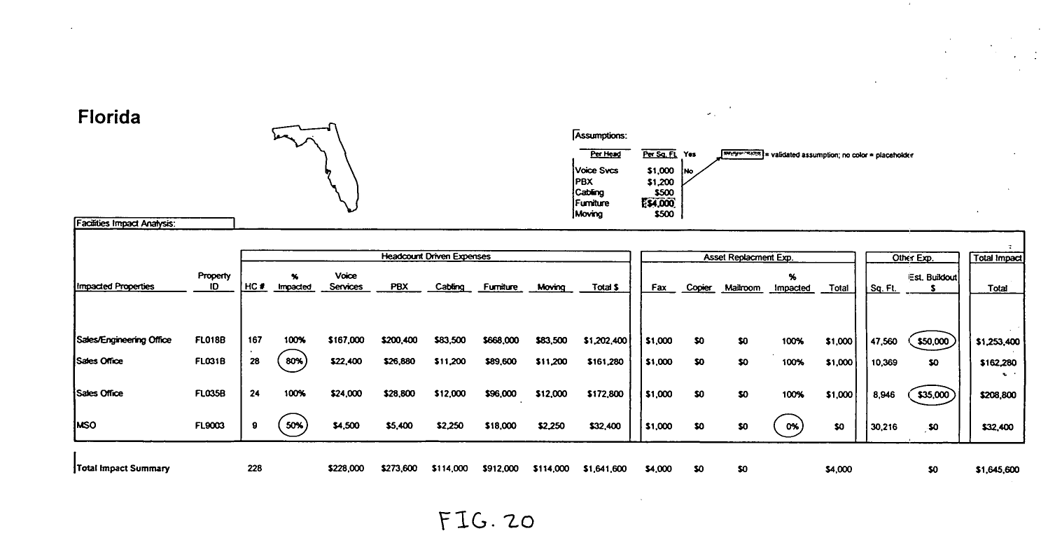

In catastrophic situations, a facility might be partially or totally destroyed. In such situations, the costs associated with build-outs of a refurbished or new facility must be considered. Such costs, include for example, labor, site acquisition costs, and construction costs. As shown in FIG. 19, the user can be presented with an interactive display of the facility impact variables. In this way, the user can select and/or enter information related to the impacted facility assets. A summary of the information is presented in FIG. 20. Once each of the above described calculations are made, asset impact management system 300 is ready to prepare and format the financial impact analysis report. Thus, control returns to step 815 (FIG. 8).

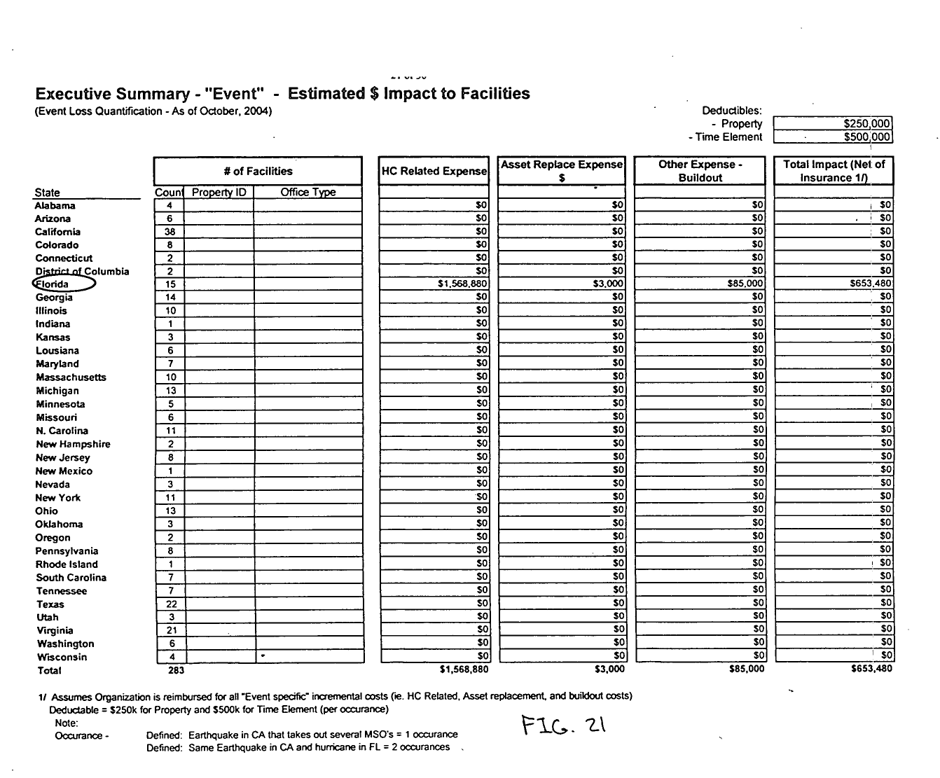

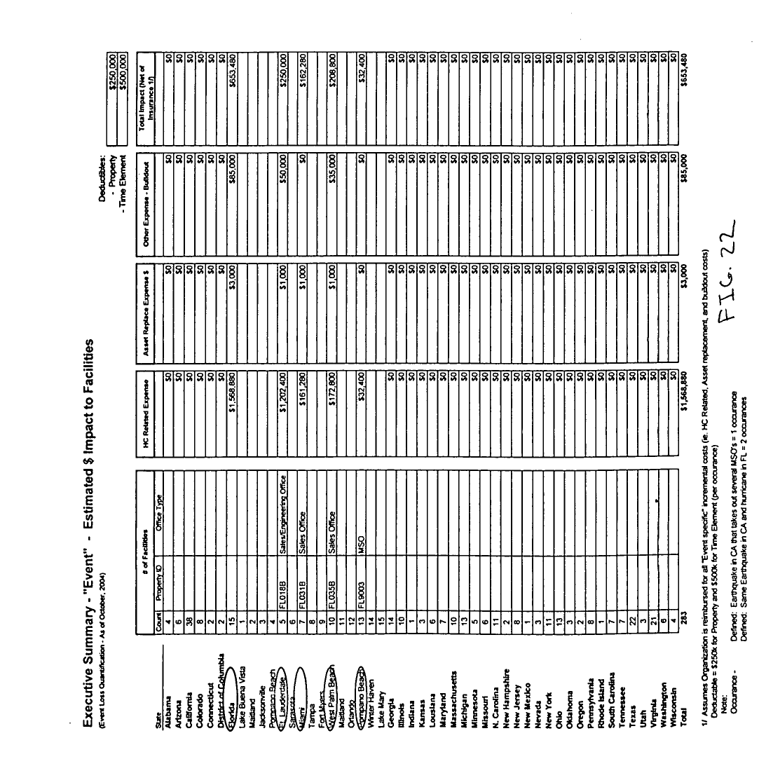

FIGS. 21 and 22 illustrate example screen shots of a financial impact analysis report presented to a user according to an embodiment of the present invention. Referring first to FIG. 21, the user is able to see a high level assessment of the estimated financial impact that an event has on the organization's financial assets. In this case, an initial view by state is presented. In an embodiment of the present invention, the user can drill down for more detailed information by selecting a particular state. As shown in FIG. 22, the financial impact for each of the Florida locations having impacted facility assets is displayed. In an embodiment of the present invention, one or more of the facility impact variables can be modified. For example, referring again to FIG. 19, a user might indicate that the Sales/Engineering Office in Ft. Lauderdale is only 50% affected as opposed to the originally estimated 100%. According to embodiments of the present invention, the financial impact analysis report is updated whenever the facilities impact variables are modified.

In an embodiment of the present invention, the financial impact analysis report is sent to persons identified on a contact list associated with the impacted facility. In this way, engineers, technicians, managers or others needing to be involved in the early assessment or response to an event can be quickly notified. The system may be configured to send the report to such persons automatically or in response to a user request. The user request can be made in any well known manner, such as selecting an icon or activating a button.

C. Sales Impact Assessment

A third example implementation of the invention will now be described in the context of determining the financial impact of an event affecting the sales locations of an organization. Accordingly, in response to a user's selection of the sales segment of an organization, a sales segment identifier would be provided to asset impact management module 310. In response to receiving the sales segment identifier, asset impact management module 310 would utilize sales segment impact module 306 to identify the location where the organization has sales assets.

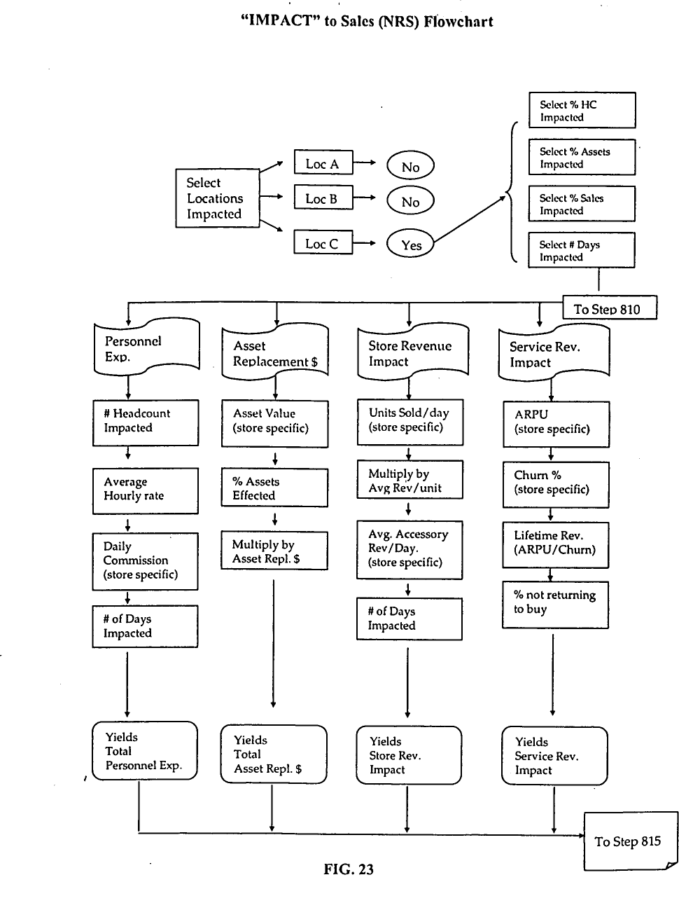

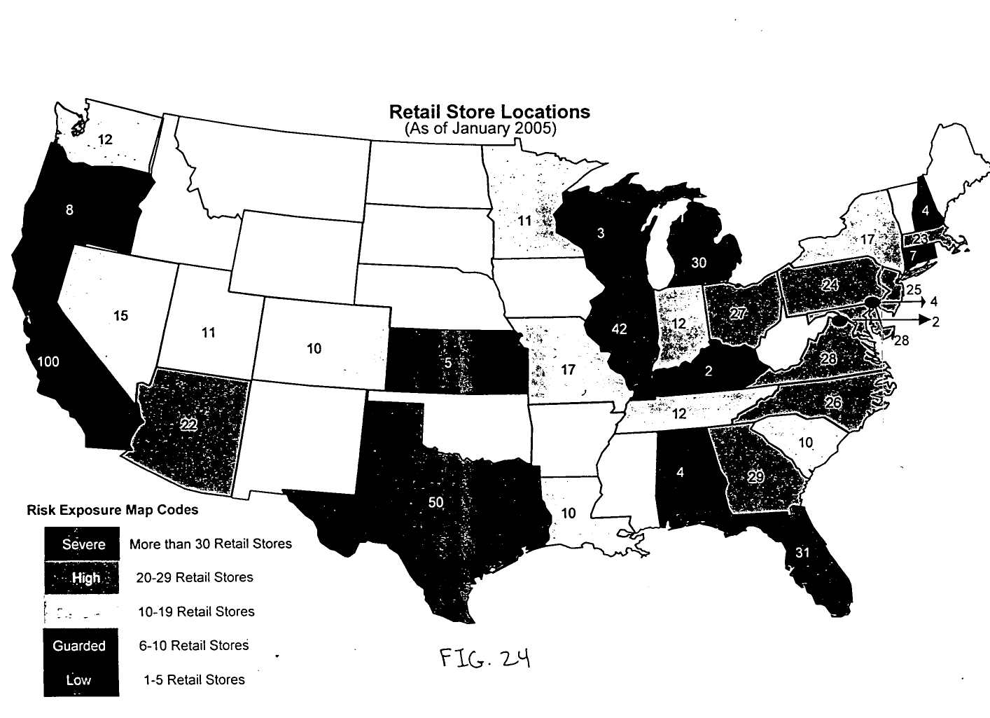

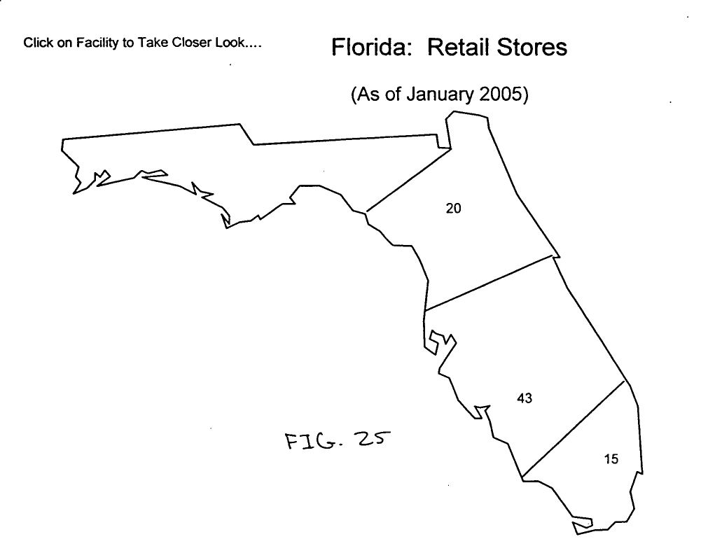

According to embodiments of the present invention, information identifying the location where the organization has sales outlets is obtained from asset database 305, location database 705, or a combination of the two. Continuing with the hurricane scenario and referring now to FIG. 23, the user is asked to identify the impacted sales locations. As shown in FIG. 24, in an embodiment of the present invention, the locations of the organization's sales outlets are presented on an interactive geographical display. Still further, the display might also indicate the number of sales outlets located in a particular geographic location. In this way, the user is able to quickly identify the number of potentially impacted sales outlets. The display might also indicate the risk level associated with a particular geographic location. In the present example, the user selects the state of Florida. As shown in FIG. 25, in embodiments of the present invention, the impacted locations can be further identified by selecting a subset of the selected geographical area. Once the impacted locations are selected, impact location identifiers are provided to sales segment impact module 306. In an embodiment, an impact location identifier is provided for each of the selected locations. Sales segment impact module 306 then retrieves an impact location profile for each of the impact location identifiers. In an embodiment, each impact location profile includes information identifying the sales outlets associated with the respective impacted locations. For a telecommunications company, examples of such sales outlet assets include, without limitation, corporate retail sales stores.

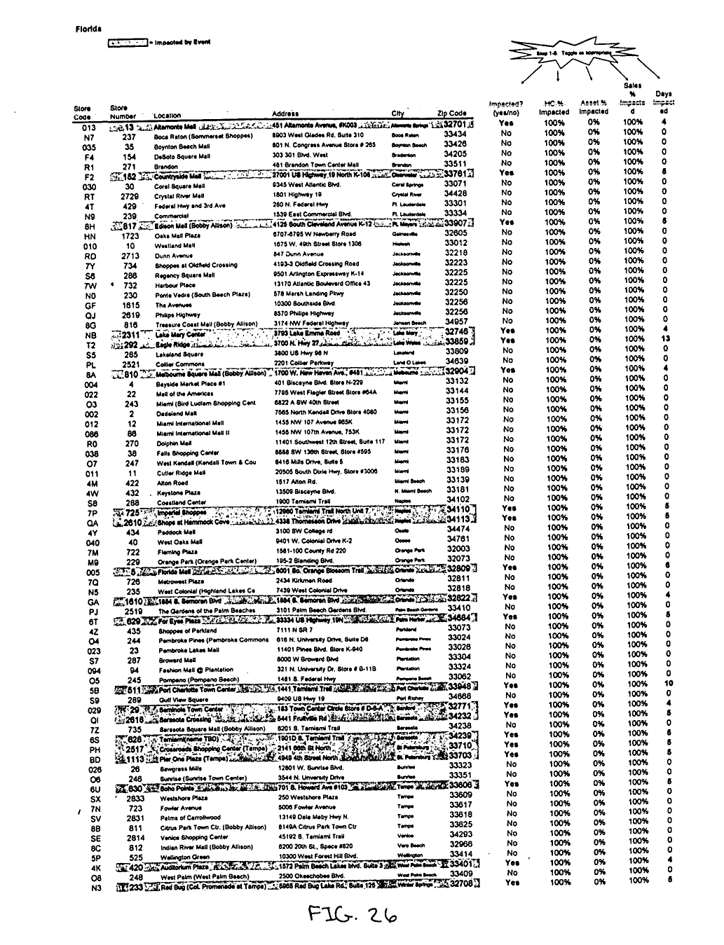

Referring to FIG. 26, in an embodiment of the present invention, the user is presented with a list of each of the sales outlets and prompted to identify those sales outlets impacted by the hurricane. A few examples of the sales outlets identified by the user include store numbers 13, 152, 817, and 725. In the present example, the user would also indicate a number of sales impact variables to be considered, such as, the extent to which a particular sales outlet has been impacted or the number of personnel affected at the impacted sales outlet. Such personnel might include employees who work at the impacted sales outlets and find themselves unable to enter the workplace because of the damage. Using store number 152 for example, the user has indicated that one hundred percent (100%) of the personnel have been affected by the event. Additional sales impact variables include, for example, the extent to which physical assets located within the sales outlet have been affected, the extent to which sales at the impacted sales outlet have been affected, and the duration of the impact. Referring again to store number 152, the user has indicated that none of the physical assets have been impacted. However, one hundred percent (100%) of the stores sales have been impacted. The duration is identified as lasting five (5) days.

In an embodiment of the present invention, the user may be located at the impacted sales outlet. In this way, the user's determination of the impact can be based on a direct visual assessment of the assets. In another embodiment, persons at the impacted sales outlets might provide information about the impacted assets to a remotely located user who then provides such information to the system.

Once the scope of the impact to the organization's sales outlets has been determined, a financial impact analysis can be performed in accordance with embodiments of the present invention. Referring again to FIG. 8, in step 810, financial impact analyzer determines the financial costs of the hurricane on the organization with respect to its sales outlets. One method for determining the financial costs of an event in terms of the impact on sales is shown in FIG. 23. In an embodiment, the financial costs are determined based on the determined scope of the event and a financial impact analysis of one or more of the asset impact variables. The sales impact variables can include a personnel expense parameter, an asset replacement costs parameter, a sales revenue parameter or a service revenue parameter. These parameters correspond to the information provided by the user and obtained from asset database 305 as described above in connection with step 805.

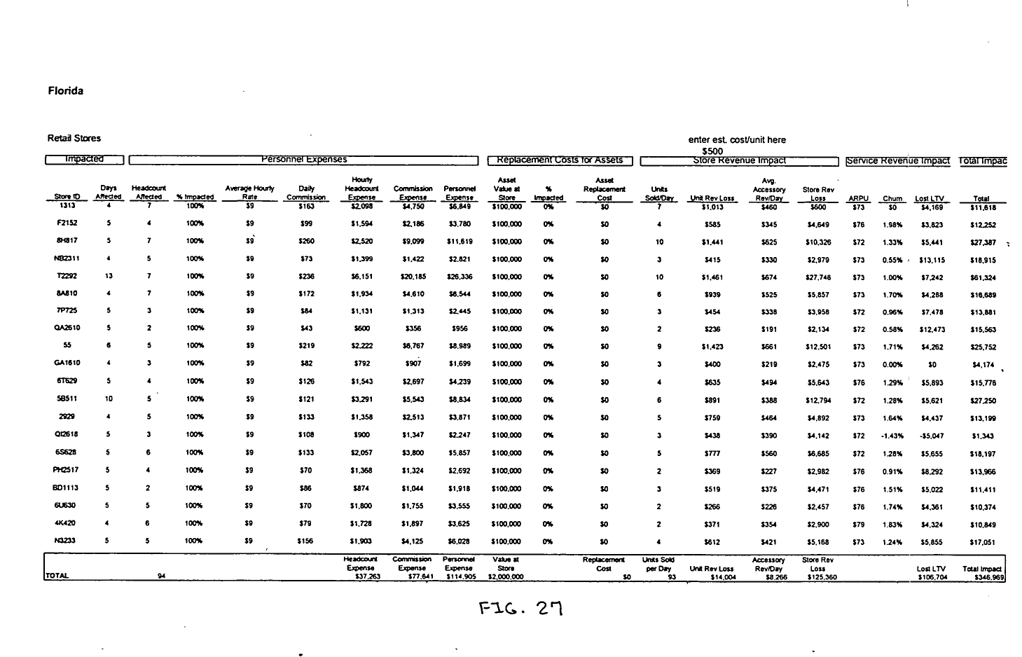

Referring again to FIG. 23, the personnel expense parameter is considered in the financial impact analysis. In an embodiment, the personnel expense parameter is determined based on the number of personnel impacted, the average hourly rate paid to such personnel, the daily commission earned from sales at the location, and the number of days the sales location is impacted. As shown in FIG. 27, store number 152 (Store ID F2152) has a total head count of four (4). Since one hundred percent (100%) of its headcount were identified as being affected, the headcount affected value is shown as four (4). The average hourly rate for the personnel is nine dollars ($9.00) per hour. The daily commission for the store is ninety nine ($99.00) dollars. Based on the impact duration of five (5) days, the personnel expense parameter for store number 152 is determined to be three thousand seven hundred and eighty ($3,780) dollars.

In some cases the impact to a sales outlet asset will require assets within the sales outlet to be replaced. For example handsets and accessories may need to be replaced. Therefore, in an embodiment of the present invention an asset replacement costs parameter is used in the financial impact analysis. In an embodiment, the replacement costs parameter is determined based upon an asset's value and the percentage of the asset affected.

The financial impact analysis may also consider the store revenue impact. Thus, in an embodiment of the present invention a sales revenue parameter is used in the financial impact analysis. The sales revenue parameter may be determined by taking the number of units sold per day and multiplying this value by the average revenue per unit. Accessory sales are another source of sales revenue. Accordingly, the sales revenue parameter may also take into account the average accessory revenue earned each day. Referring again to FIG. 27 and the information pertaining to store number 152 (Store ID F2152), the number of units sold per day is shown as four (4). The average revenue per unit is five hundred eighty-five ($585) dollars. The average accessory revenue per day is three hundred forty-five ($345) dollars. Thus, the sales revenue parameter (Store Rev Loss) is determined to be four thousand six hundred and forty-nine ($4,649) dollars based on the given impact duration of five (5) days.

The financial impact analysis may also consider the service revenue impact. Thus, in an embodiment of the present invention a service revenue parameter is used in the financial impact analysis. The service revenue parameter may be determined based upon the average return per unit (ARPU), percentage of customers switching to a competitor (Chum), lifetime revenue (LTV), and the percentage of customers not returning to buy after the sales outlet is reopened. Once the above described calculations are made, asset impact management system 300 is ready to prepare and format the financial impact analysis report. Thus, control returns to step 815 (FIG. 8).

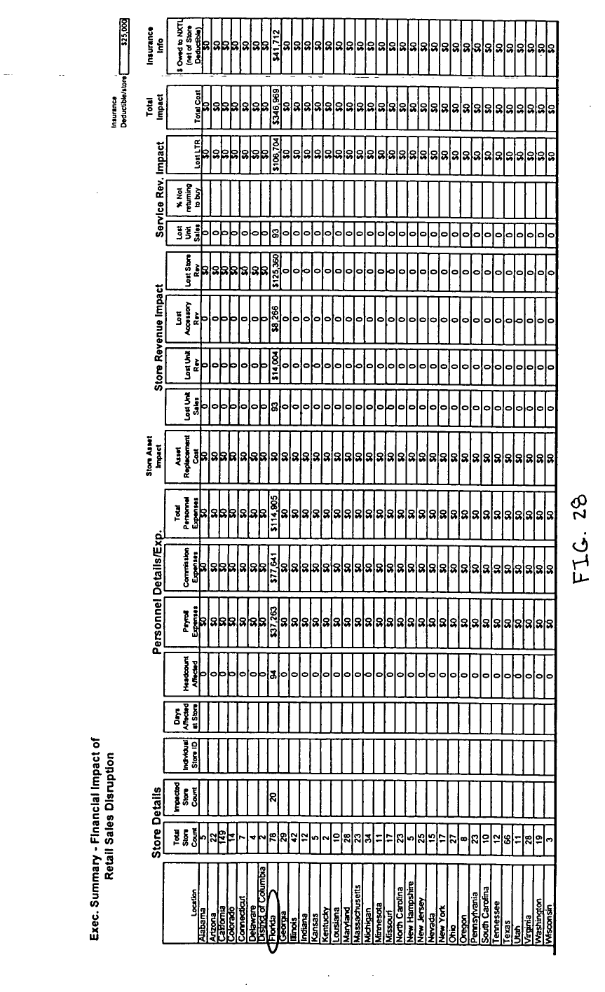

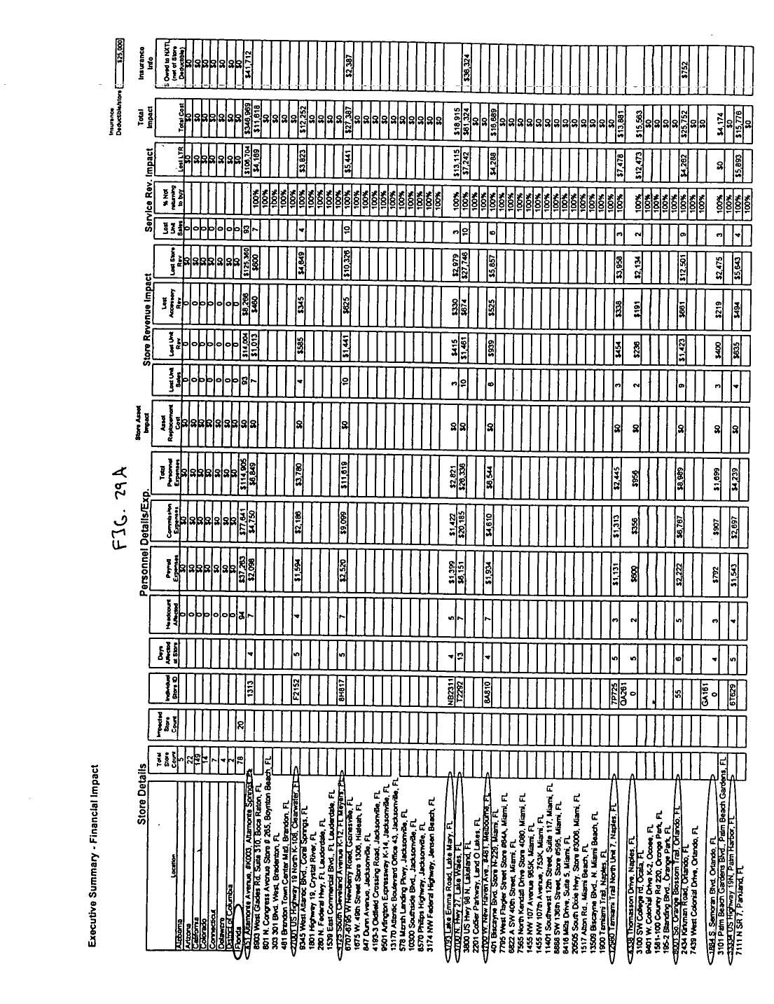

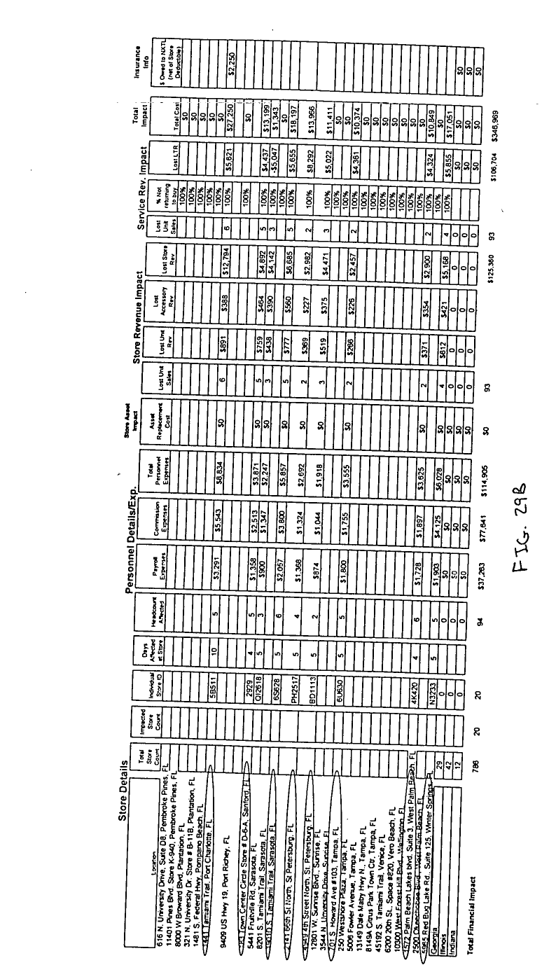

FIGS. 28 and 29A-B illustrate example screen shots of a financial impact analysis report presented to a user according to an embodiment of the present invention. In an embodiment of the present invention, the financial impact analysis report is sent to persons identified on a contact list associated with the impacted sales outlet. In this way, executives, managers, or others needing to be involved in the early assessment or response to an event can be quickly notified. The system may be configured to send the report to such persons automatically or in response to a user request. The user request can be made in any well known manner, such as selecting an icon or activating a button.

Referring first to FIG. 28, the user is able to see a high level assessment of the estimated financial impact that an event has on the organization's sales assets. In this case, an initial view by state is presented. In an embodiment of the present invention, the user can drill down for more detailed information by selecting a particular state. As shown in FIGS. 29A and 29B, the financial impact for each of the Florida locations having impacted sales outlets is displayed. In an embodiment of the present invention, one or more of the sales impact variables can be modified. For example, referring again to FIG. 26, a user might indicate that 50% of the assets at the Countryside Mall sales outlet have been affected as opposed to the originally estimated 0%. According to embodiments of the present invention, the financial impact analysis is updated whenever the sales impact variables are modified.

D. Customer Impact Assessment

In embodiments of the present invention, the financial impact analysis takes into account which of the organization's customers would be affected by a real or hypothetical event impacting the organization's assets. For example, different call centers may be responsible for servicing the needs of specific customers. In the event multiple call centers go out of service, priority might be given to bringing those call centers servicing the organization's premium customers back online first. In another example, it might be that the organization provides some of its customers with dedicated telecommunications lines to meet agreed upon quality of service obligations. In such cases, the organization may want to escalate the recovery of any outages affecting such customers. Accordingly, in embodiments of the present invention, customer impact identifiers identifying which of the organization's customers are affected by a real or hypothetical event impacting the organization's assets are provided.

Disaster Recovery Plans

The resultant financial impact analysis report provides the decision makers in an organization with useful information for determining an event's impact on the organization. While the information is helpful, the decision makers must still determine a plan for responding to the event. Therefore, in an embodiment, the resultant financial impact analysis is used to generate one or more disaster recovery plans. Such disaster recovery plans suggests the steps the organization should take in response to the event. Once the organization's decision makers have decided on a particular disaster recovery plan, the plan can be routed to the appropriate individuals for execution.

While various embodiments of the present invention have been described above, it should be understood that they have been presented by way of example only and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

We claim:

1. An impact management system for determining the financial costs of an event impacting one or more locations, comprising:
a storage device that stores an impact location profile for each of one or more impact location identifiers;
an asset impact management module, operably in communications with the storage device, for identifying the impact location profile corresponding to the impact location identifier; and
a financial impact analyzer, wherein the financial impact analyzer uses the impact location profile for each location identified by the impact location identifier and one or more asset impact variables to determine the financial costs of an event.

2. The system of claim 1, wherein the one or more asset impact variables include an asset impact parameter, a sales impact parameter, and an impact duration parameter.

3. The system of claim 2, wherein the asset impact management module retrieves at least one segment area analysis identifier.

4. The system of claim 3, wherein the financial impact analyzer uses at least one segment area impact variable associated with the segment area analysis identifier to determine the financial costs of an event.

5. The system of claim 4, wherein the segment area impact variable is a network impact variable, the network impact variable including a lost revenue parameter, an asset replacement cost parameter, or a build-out cost parameter.

6. The system of claim 4, wherein the segment area impact variable is a facilities impact variable, the facilities impact variable including a headcount driven parameter, an asset replacement cost parameter, or a build-out cost parameter.

7. The system of claim 4, wherein the segment area impact variable is a sales impact variable, the sales impact variable including a personnel expense parameter, an asset replacement cost parameter, a sales revenue parameter, or a service revenue parameter.

8. The system of claim 1, further comprising a user interface for entering the impact location identifiers and one or more asset impact variables.

9. The system of claim 8, further comprising an external device consisting of one of a personal computer, wired device, wireless device, mobile device, cell phone, personal data assistant, and electronic tablets; and
wherein the user interface is a component of the external device.

10. The system of claim 1, wherein the financial impact analyzer generates a financial impact analysis report.

11. The system of claim 10, further comprising a display for displaying the financial impact analysis report.

12. The system of claim 10, further comprising one or more disaster recovery plans generated in response to the financial impact analysis report.

13. The system of claim 10, wherein the display also displays a geographical display of locations where one or more assets are located.

14. The system of claim 13, wherein the one or more assets are represented on the geographical display by asset type indicators.

15. The system of claim 13, wherein a risk exposure indicator is used to visually indicate the respective risk levels determined for the locations where one or more assets are located.

16. The system of claim 1, further comprising one or more customer impact identifiers associated with the asset impact variables, the customer impact identifiers identifying customers affected by the event.

17. A method for determining the financial costs of an event impacting one or more locations, comprising the steps of:
receiving one or more segment area analysis identifiers;
receiving one or more asset impact variables associated with the segment area analysis identifiers; and
performing a financial impact analysis using the one or more asset impact variables to determine the financial costs of the event.

18. The method of claim 17, wherein the one or more asset impact variables include an asset impact parameter, a sales impact parameter, or an impact duration parameter.

19. The method of claim 18, further comprising the step of modifying at least one of the asset impact variables.

20. The method of claim 19, further comprising the step of updating the financial impact analysis in accordance with the modified asset impact variables.

21. The method of claim 17, wherein the step of receiving one or more segment area analysis identifiers comprises the step of receiving a network segment identifier.

22. The method of claim 21, further comprising the step of using one or more network impact variables in the financial impact analysis.

23. The method of claim 22, wherein the network impact variables include at least one of a lost revenue parameter, an asset replacement cost parameter, or a build-out cost parameter.

24. The method of claim 17, wherein the step of receiving one or more segment area analysis identifiers comprises the step of receiving a facilities segment identifier.

25. The method of claim 24, further comprising the step of using one or more facilities impact variables in the financial impact analysis.

26. The method of claim 25, wherein the facilities impact variables include at least one of a headcount driven parameter, an asset replacement cost parameter, or a build-out cost parameter.

27. The method of claim 17, wherein the step of receiving one or more segment area analysis identifiers comprises the step of receiving a sales segment identifier.

28. The method of claim 27, further comprising the step of using one or more sales impact variables in the financial impact analysis.

29. The method of claim 28, wherein the sales impact variables include at least one of a personnel expense parameter, an asset replacement cost parameter, a sales revenue parameter, or a service revenue parameter.

30. The method of claim 17, further comprising the step of using one or more network impact variables, one or more facilities impact variables, and one or more sales impact variables in the financial impact analysis.

31. The method of claim 17, further comprising the step of preparing and formatting a financial impact analysis report based on the financial impact analysis.

32. The method of claim 31, further comprising the step of preparing and formatting one or more disaster recovery plans based on the financial impact analysis report.

33. The method of claim 31, further comprising the step of displaying the financial impact analysis report.

34. A computer program product for determining the financial costs of an event impacting one or more locations, comprising:
a computer readable medium that stores an impact location profile for each of one or more impact location identifiers;
an asset impact management module comprising a controller, operably in communications with the computer readable medium, the controller for identifying the impact location profile corresponding to the impact location identifier; and
a financial impact analyzer, wherein the financial impact analyzer uses the impact location profile for each location identified by the impact location identifier to determine the financial costs of an event.

35. The computer program product of claim 34, wherein the asset impact management module retrieves at least one segment area impact variable associated with a segment area analysis identifier.

36. The computer program product of claim 35, wherein the financial impact analyzer uses at least one segment area impact variable associated with the segment area analysis identifier to determine the financial costs of an event.

37. The computer program product of claim 36, wherein the asset impact management module generates a financial impact analysis report based on the determined financial costs of the event.
